(19) United States
(12) Patent Application Publication
(10) Pub. No.: US 2012/0108349 A1
(43) Pub. Date: May 3, 2012

(54) Multi-Lobed and Constant Contact Gear Mechanism

(76) Inventors: Guy Foley, Bowmanville (CA); Wiliiam Danson, Oshawa (CA)

(21) Appl. No.: 13/245,308

(22) Filed: Sep. 26, 2011

Related U.S. Application Data
(60) Provisional application No. 61/407,228, filed on Oct. 27, 2010.

(51) Int. Cl. F16D 3/06; F16B 7/00

(52) U.S. Cl. 464/162; 403/359.6

(57) ABSTRACT

A multi-lobed gear system is provided in which the lobes of an input gear and a corresponding, mating pair of lobes in an output gear are uniformly in contact. The lobed gear tooth profile of the present invention reduces material galling, shuttering and whipping within a drivetrain assembly in comparison to square or helical splines that incorporate single point contacts between meshed pairs. An internal pinion gear or slip yoke internal shaft employs a lobed gear tooth profile that forms a sinusoidal outer perimeter shape. The perimeter surface is in constant contact with the complementary shaft or gear across its entire surface. A small clearance gap may be provided for lubrication, fitment and manufacturing considerations.

### CROSS REFERENCE TO RELATED APPLICATION

This application claims the benefit of U.S. Provisional Application No. 61/407,228 filed on Oct. 27, 2010, entitled “Multi-Lobed Slip Yoke.”

### BACKGROUND OF THE INVENTION

1. Field of the Invention

The present invention relates to transmission systems and gear tooth profiles. More specifically, the present invention relates to a sinusoidal gear spline shape that forms a lobed gear, offering superior contact between meshed gears, particularly suited for automotive drivetrain applications.

2. Description of the Prior Art

Slip yokes are critical drivetrain components for trucks and off-road vehicles, and provide a means that compensates for extreme rear suspension travel in these types of vehicles. The slip yoke is an outer shaft with an inner set of splines that mate with a transmission output shaft. The output shaft is inserted into the interior of the slip yoke, which accepts its rotational output while permitting fore-aft motion of the shaft within its interior. The slip yoke and output shaft of the transmission are therefore permitted to displaced lengthwise from one another and still remain in contact, which is important for those vehicles wherein the rear crankcase or rear suspension travels a considerable distance or displaces with regard to the transmission position. The ability to compensate for relative displacement ensures continued and uninterrupted power delivery to the rear wheels, despite the position or orientation of the rear end of the vehicle.

Typical slip yokes employ a plurality of square spline gear teeth, in which the transmission output shaft and slip yoke are a complementary pair and mesh with one another using this type of gear tooth geometry. The use of square splines has been standard industry practice for many years and an effective method of transmitting torque from the transmission output shaft to the slip yoke; however their use leads to some drawbacks with regard to the reliable operation of the vehicle and the drivetrain assembly. Square splines create a high magnitude of stress at the contact points along the splines during operation, which is brought on by clashing and single-point contacts at the spline contact interface. Square splines commonly create shutters throughout the drivelines, develop material galling, allow the cross yokes to deteriorate rapidly and allow for output shaft damage of the transmission in some cases.

The present invention provides a new type of slip yoke and transmission output shaft interface, wherein a plurality of lobes are utilized to transmit torque in a uniform configuration that reduces single point contacts and the common drawbacks related to square spline shafts. The lobes of the present invention is a sinusoidal pattern that provides uniform contact across the slip yoke-transmission output shaft contact surface, which distributes stress across a plurality of lobes instead of creating high stress concentration areas.

Several devices have been patented in the prior art that disclose curved gear splines; however none are described specifically for a slip yoke application, and none fully disclose the elements of the present invention. The curved splines of the prior art are generally related to new gear profiles in gear train application wherein a single point contact is still maintained, whereas the present invention attempts to remove these singularities and distribute load across a greater area. The present invention prevents shuttering or whipping in a drive train, as well as damage in the form of material galling and component structural failure. The rounded splines are intended to improve stability of the system and decrease component stress by reducing clashing and single-point contacts between splines, as typical in involute gearing systems.

One such device in the prior art is U.S. Pat. No. 6,964,210 to Colbourne, which describes a gear and a method for producing a gear that results in conjugate mating throughout most of the dedendum and addendum, but includes a transition zone between the two having no contact. This gear tooth configuration provides a relief around a transition zone wherein the dedendum becomes the addendum. While the gear teeth are rounded, they define a specific contact point and a region of relief about a transition region. Its structure and intent differs from the present invention.

Similarly, U.S. Pat. No. 3,709,055 to Grove describes gear tooth profiles having circular tip arcs and circular dedendum arcs with straight line flanks. A method for designing such gears is described using isosceles triangles. The Grove gear describes circular arcs for gear teeth, but does not contemplate constantly meshed or conjugate gears in which the gears are in uniform contact with one another. The present invention provides a new style gear design in which the lobes of the gear are in near uniform contact with a hub or similar structure, preventing backlash and shuttering in the mechanism.

U.S. Pat. No. 3,180,172 to Leggatt describes an improvement in gear wheels and racks in which the profiles of the gear teeth are based on arcs of circles. The profiles of the teeth at each transverse cross-section are concave curves for use with a complementary gear wheel or rack in which the center of curvature of each tooth at each transverse cross-section lies on the side of the pitch cylinder of the gear wheel. The Leggatt patent describes a type of helical gear pitch; however the design of the gears does not rely on uniform contact between mating pairs of a gear and a complementary hub or rack, as described by the present invention. The Leggatt patent describes the profile of gear teeth in a conventional meshed gearing system, wherein contact between pairs of teeth occur at a specific location around the gear perimeter.

Finally, U.S. Pat. No. 4,922,781 to Peiji describes a cycloidal equidistant and curved gear transmission mechanism with one-tooth, zero-tooth or multi-tooth difference for smaller sliding coefficients and pressure angle, greater speed ratio, lower noise and other benefits. The Peiji device does not describe a uniform-contact conjugate pair of gears as described by the present invention. The present invention provides a gearing pair with minimal clearances between pinion and gear or gear and hub interface surfaces across their entire outer surface at a given time. Minimal clearance is provided for lubrication and manufacturing; however the pair is designed to maintain near-uniform contact throughout its operation.

The present invention describes a gear profile in which a continuous plurality of lobes are provided for uniformly contacting a mating interface, such as a slip joint, gear or similarly structured hub. It substantially diverges in design elements from the prior art and consequently it is clear that there is a need in the art for an improvement to existing drivetrain interface devices. In this regard the instant invention substantially fulfills these needs.

### SUMMARY OF THE INVENTION

In view of the foregoing disadvantages inherent in the known types of gear spline designs now present in the prior art, the present invention provides a new lobed gear interface wherein the same can be utilized for providing convenience for the user when providing an improved, efficient and robust means of transferring torque between vehicle drivetrain components.

It is therefore an object of the present invention to provide a new gear lobe device that has all of the advantages of the prior art and none of the disadvantages.

Another object of the present invention to provide a lobed gear interface that provides uniform contact across its entire outer surface to improve durability, reduce mechanical stress on components and improve torque transmission capability.

Another object of the present invention is to provide lobed gear interface that incorporates a sinusoidal outer surface profile, adapted for meshing with a complementary surface for transmitting torque from one element to the other.

Another object of the present invention is to provide a lobed gear device that provides a minimal clearance between contacting interfaces to accommodate for lubrication, heat expansion and contraction and other manufacturing and operating considerations.

Yet another object of the present invention is to provide a lobed gear device that is particularly suited for slip yoke applications and other vehicle drivetrain dynamic components.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention being utilized in a slip yoke application, wherein torque is being transmitted from a vehicle transmission output shaft to a slip yoke.

FIG. 2 shows an end perspective view of the present invention utilized on a vehicle slip yoke.

FIG. 3 shows an end view of a lobed gear as described by the present invention.

FIG. 4 shows the sinusoidal surface of a lobed gear as described by the present invention.

### DETAILED DESCRIPTION OF THE INVENTION

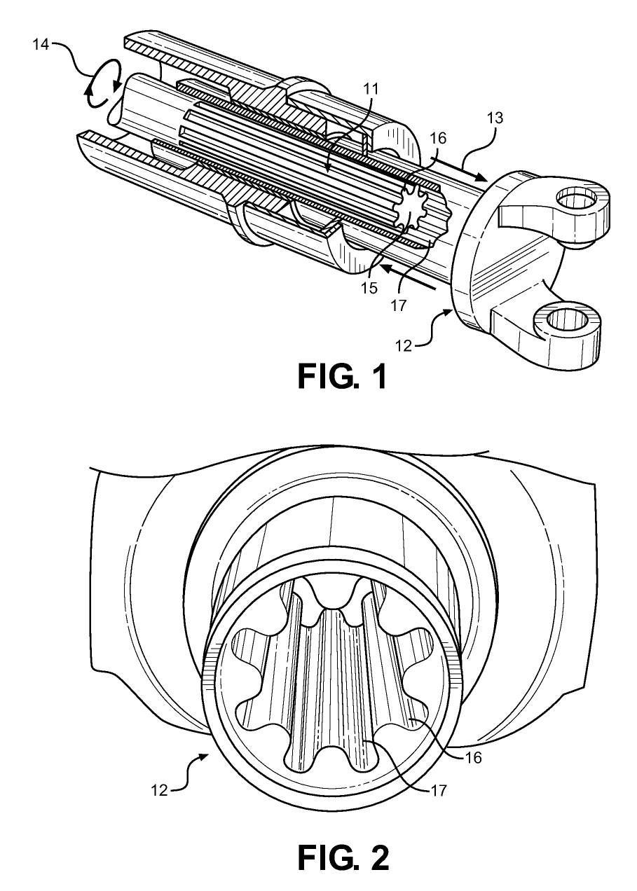

Referring now to FIG. 1, there is shown a view of the present invention being utilized in a vehicular slip yoke configuration, wherein torque 14 is being supplied from a vehicle transmission output shaft 11 to a slip yoke 12 at the rear axle of a vehicle. The transmission output shaft 11 is a shaft from the vehicle transmission that is utilized to power the rear wheels of a truck or similar vehicle. In this application, the shaft 11 is slideably mounted within a corresponding slip yoke 12 shaft. The connection between the two allows the transmission shaft 11 and slip yoke 12 to displace 13 with regard to one another and still remain in contact. The present invention is being employed at the slip yoke 12 and shaft 11 interface, wherein splines of the shaft 11 are generally utilized to transmit torque from one structure to the other. The splines of the present invention are alternatively a plurality of lobes 16, which are formed from a sinusoidal outer surface profile 17 that forms the interface between the yoke 12 and shaft 11. The profile of the lobes permits the two mating pairs to be in near uniform contact with one another throughout a revolution, as opposed to typical splines which have single point contacts during a short engagement period. The shape of the lobes 16, most notably its rounded structure, improves its mechanical strength and therefore the durability of the device. Traditional square splines are utilized in this application, which are prone to failure or are limited in output torque capability. An end view 15 profile of the lobed shaft 11 shows the shape and profile of the lobes.

Referring now to FIG. 2, there is shown a perspective end view of the vehicle slip yoke 12. In this view, the lobes 16 of the interface and the mating surface 17 of the yoke 12 are visualized. The lobes comprise rounded structures that form semi-circular protrusions that couple with corresponding, semi-circular valleys in a meshed pair. The lobe protrusion and valley stay coupled to one another throughout the revolutions of the joint, permitting uniform and constant contact between the two at their interface. A small clearance may be provided, wherein one thousands of an inch clearance is provided per inch in diameter of the device. This clearance allows for material expansion and contraction, for proper lubrication of the interface, along with manufacturing considerations, fitment and operational considerations.

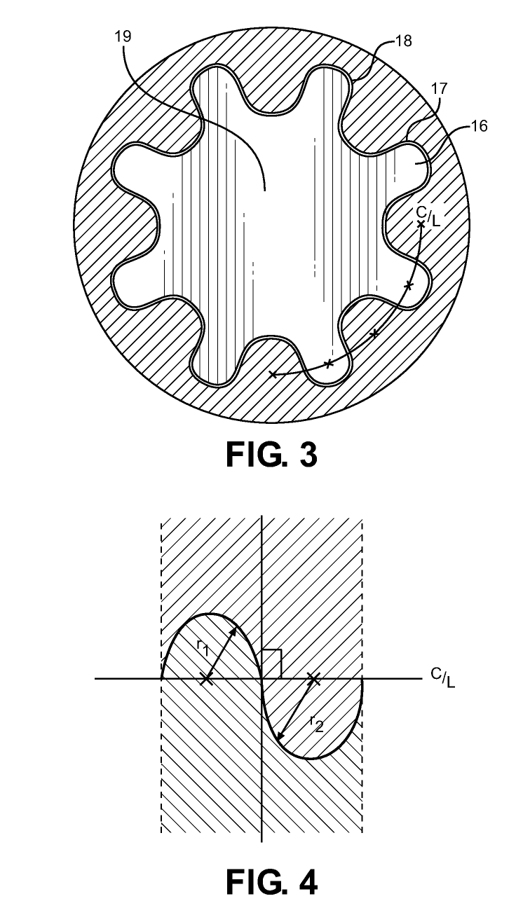

Referring now to FIG. 3, there is shown an end view of the present invention, wherein a lobed, inner shaft 19 is mated with a lobed, outer shaft 18. The both shafts employ a lobed profile 17 and a plurality of lobe protrusions 16, which act as a mating pair to transfer rotation and torque from one shaft to the other with minimal clearance. The profile of the lobes 16 allows near-uniform contact, spreading contact load among the plurality of lobes 16 and reducing single point stress concentrations that can lead to material or spline failure. The centerline (C/L) of the lobe profile is shown, and illustrated in graph form in FIG. 4.

Referring now to FIG. 4, there is shown a view of the lobe profile as viewed from the centerline of the sinusoidal lobe profile. In this view, one lobe protrusion and valley is shown with respect to the centerline. The lobes are rounded protrusions that are formed by truncated circles with a given radius. The radius of each lobe is identical, allowing for a plurality of the same lobes that form an outer profile utilized as a contact surface. The number of lobes around a given shaft or at a joint is dependent on the load and torque requirements and the perimeter defining the connection interface.

In use, a lobed profile provides improved torque and load transfer capabilities as opposed to square splines or other traditional spline interfaces. The profile of the lobes provides uniform and constant contact, which distributes load between the lobes and reduces singularities. The constant contact between opposing gear teeth prevents shuttering or whipping in a vehicle drive train, as well prevents damage in the form of material galling and component structural failure. Benefits of this lobed design include financial savings gained by reduced maintenance and replacement costs. The rounded lobes can replace current square-spline yokes currently used throughout the transportation industry, which enable the vehicle driveline to shorten and lengthen as vehicles move over uneven surfaces. It may also allow for the carrying of heavy weight without loss of torque, particularly on high grades in the road or uneven terrain.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A drivetrain interface device, comprising:
a first plurality of gear teeth on a shaft outer surface, a second plurality of gear teeth on a hub interior;
said shaft adapted to fit within said hub, said first and second plurality of gear teeth comprising a corresponding mating pair;
said gear teeth profiles being rounded lobes with a sinusoidal pattern, having a plurality of raised protrusions and valleys;
said mating pair adapted to maintain uniform contact during rotation of either said shaft or said hub.

2) The device of claim 1, wherein said uniform contact further comprises a minimal clearance between said shaft and said hub mating pair.

3) The device of claim 1, wherein said hub is a slip joint, adapted to incorporate translation along said shaft without losing contact therewith.

4) A drivetrain interface device, comprising:
a first plurality of gear teeth on a first gear outer surface, a second plurality of gear teeth on a second gear surface;
said first and second plurality of gear teeth comprising a corresponding mating pair;
said gear teeth profiles being rounded lobes with a sinusoidal pattern, having a plurality of raised protrusions and valleys;
said mating pair adapted to maintain uniform contact during rotation of either said first or second gear.

5) The device of claim 1, wherein said uniform contact further comprises a minimal clearance between said first and second gear mating pair.
